(19) United States
(12) Patent Application Publication
(10) Pub. No.: US 2005/0166201 A1
(43) Pub. Date: Jul. 28, 2005

(54) Method of without installing applications in an electronic device in advance

(75) Inventor: Chang-Chin Lai, Taipei (TW)

Correspondence Address: BACON & THOMAS, PLLC, 625 SLATERS LANE, FOURTH FLOOR, ALEXANDRIA, VA, 22314, US

(73) Assignee: INVENTEC CORPORATION, Taipei (TW)

(21) Appl. No.: 10/761,194

(22) Filed: Jan. 22, 2004

(51) Int. Cl. G06F 9/445

(52) U.S. Cl. 717/174

(57) ABSTRACT

The present invention is to provide a method of without application installation comprising installing an application in a memory device (e.g., portable disk) in advance, connecting the memory device to an electronic device (e.g., personal computer) prior to use, automatically copying the application as a linked shortcut in an OS of the electronic device, showing an icon of the shortcut on a screen of the electronic device, and clicking the icon for opening the application, thereby enabling the electronic device to run the application without installing the same in a hard disk of the electronic device.

### FIELD OF THE INVENTION

The present invention relates to software installation and more particularly to a method of connecting a memory device (e.g., portable disk, memory card, or the like) to an electronic device (e.g., notebook computer, PDA (Personal Digital Assistant), or the like) for automatically copying one or more applications to the electronic device for use and thus eliminating the need of installing the same in the electronic device in advance.

### BACKGROUND OF THE INVENTION

There is a rapid, spectacular development of electronics technology in recent years. People can retrieve nformation from millions of sources in this information age in an even faster speed. Accordingly, amount of data being transferred grows significantly. People heavily rely on computers in processing data and exchanging information with other people in their daily life. Thus, computers have become a ubiquitous tool for both personal and work related tasks. This in turn speeds up the development of high-technology industries (e.g., electronics).

A typical application is able to process a large amount of data because people want powerful computers to be available. Hence, the main routine of the typical application has a very large memory size. For example, it may occupy at least 300 MB. Also, it is known that such application has to be installed in an OS (operating system) of a computer prior to running. Inevitably, a computer test employee has to install an application in a computer to be tested one by one in the assembly line. Next, the required test on each computer may begin. In view of the above, it is very inconvenient. To the worse, illegal copying may occur. This thus violates the applicable copyright law. Hence, a need for improvement exists.

### SUMMARY OF THE INVENTION

One object of the present invention is to provide a method of without application installation comprising installing an application in a memory device (e.g., portable disk) in advance, connecting the memory device to an electronic device (e.g., personal computer) prior to use, automatically copying the application as a linked shortcut in an OS of the electronic device, showing an icon of the shortcut on a screen of the electronic device, and clicking the icon for opening the application, thereby enabling the electronic device to run the application. By utilizing the present invention, it is possible of running an application without installing the same in a hard disk of an electronic device.

Another object of the present invention is to provide a memory device having a plurality of applications installed in memory thereof. Each application has a corresponding autorun.bat. The memory device can be electrically connected to the electronic device by inserting the USB connector of the memory device into the USB port of the electronic device. Next, each of the applications automatically copies itself as a linked shortcut in the OS of the electronic device. These icons of the shortcuts are shown on the screen of the electronic device. In use, a user may click one of the icons for opening the autorun.bat of the corresponding application. As a result, the electronic device is enabled to run the application.

The above and other objects, features and advantages of the present invention will become apparent from the following detailed description taken with the accompanying drawings.

### BRIEF DESCRIPTION OF THE DRAWINGS

FIG. 1 is a flow chart diagram according to the invention.

### DETAILED DESCRIPTION OF THE PREFERRED EMBODIMENTS

The invention is directed to a method of without application installation comprising installing an application in a memory device (e.g., portable disk, memory card, or the like) in advance, connecting the memory device to an electronic device (e.g., personal computer, PDA, notebook computer, or the like) prior to use, automatically copying the application as a linked shortcut in an OS of the electronic device, showing an icon of the shortcut on the screen of the electronic device, and clicking the icon for opening the application, thereby enabling the electronic device to run the application.

In one embodiment of the invention, the memory device is a portable disk having a USB (Universal Serial Bus) connector. The memory device is adapted to connect to an electronic device by inserting the USB connector into a USB port of the electronic device. Memory of the memory device has an installed application (e.g., WS-FTP). The application has an embedded autorun.bat. The electronic device is a notebook computer. The electronic device has at least one USB port so that the memory device may connect thereto.

The memory device can be electrically connected to the electronic device by inserting the USB connector into the USB port. Next, the application automatically copies itself as a linked shortcut in an OS of the electronic device and shows an icon of the shortcut on the screen of the electronic device. In use, a user may click the icon for opening the autorun.bat of the application. Finally, the electronic device is enabled to run the application.

In another embodiment of the invention, a plurality of applications are installed in memory of the memory device. Each application has a corresponding autorun.bat. The memory device can be electrically connected to the electronic device by inserting the USB connector into the USB port of the electronic device. Next, each of the applications automatically copies itself as a linked shortcut in an OS of the electronic device. These icons of the shortcuts are shown on the screen of the electronic device. In use, a user may click one of the icons for opening the autorun.bat of the corresponding application. Finally, the electronic device is enabled to run the application.

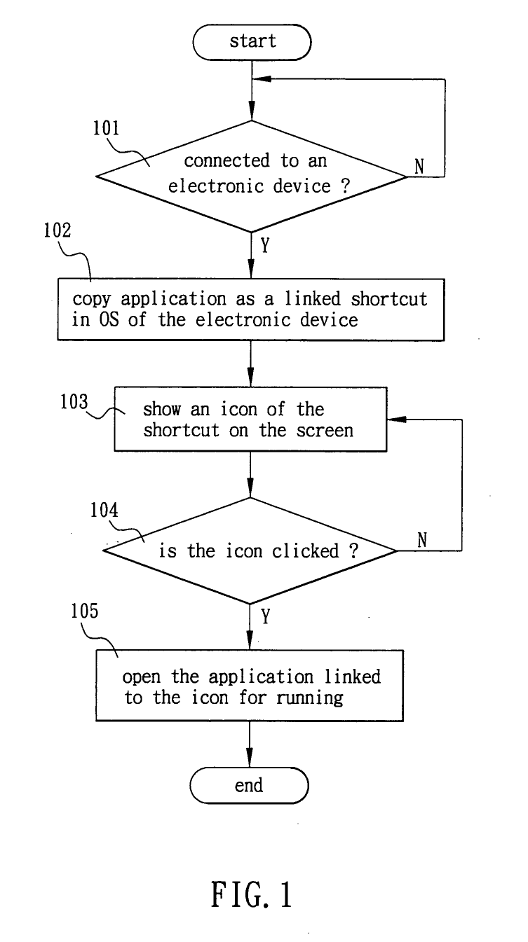

Referring to FIG. 1, there is shown a flow chart in accordance with the invention. Running the application in the memory device will cause a microprocessor of the memory device to run the following steps:

In step 101, it is determined whether the memory device is electrically connected to the electronic device. If yes, the process goes to step 102. Otherwise, the process loops back to itself.

In step 102, the application automatically copies itself as a linked shortcut in an OS of the electronic device.

In step 103, show an icon of the shortcut on the screen of the electronic device.

In step 104, it is determined whether the icon of the shortcut is clicked. If yes, the process goes to step 105. Otherwise, the process loops back to step 103.

In step 105, open the autorun.bat linked to the application in memory of the memory device. Finally, the electronic device is enabled to run the application. The process then ends.

In brief, the invention can run an application without installing the same in the hard disk of an electronic device. Also, the application can be run in a plug and play manner by connecting the memory device to the electronic device. This can eliminate problems associated with software installation and thus save installation time. Further, no software installation means lower possibility of being illegally copied. This can protect copyright of the application entitled to each user. Furthermore, this is a modular design for facilitating management, thereby significantly reducing the probability of being malfunctioned. As an end, the use of the invention is very convenient.

While the invention has been described by means of specific embodiments, numerous modifications and variations could be made thereto by those skilled in the art without departing from the scope and spirit of the invention set forth in the claims.

1. A method of without application installation comprising the steps of:
installing an application in a memory device in advance;
connecting the memory device to an electronic device prior to use;
automatically copying the application as a linked shortcut in an OS of the electronic device;
showing an icon of the shortcut on a screen of the electronic device; and
clicking the icon for opening the application, thereby enabling the electronic device to run the application.

2. The method of claim 1, wherein the memory device is a portable disk having a USB connector so that the memory device is adapted to connect to the electronic device having a USB port by inserting the USB connector into the USB port.

3. The method of claim 2, wherein the electronic device is a notebook computer having at least one USB port so that the memory device may connect to the electronic device.

4. The method of claim 3, wherein the application has an embedded autorun.bat so that responsive to connecting the memory device to the electronic device, the application automatically copies itself as a linked shortcut in the OS of the electronic device, the icon of the shortcut is shown on the screen of the electronic device, and a clicking of the icon opens the autorun.bat of the application, and the electronic device is enabled to run the application.

5. The method of claim 1, wherein the electronic device is a PDA.

6. The method of claim 1, wherein the memory device is a memory card.
